(19) United States
(12) Patent Application Publication
(10) Pub. No.: US 2020/0227834 A1
(43) Pub. Date: Jul. 16, 2020

(54) ANTENNA FEEDING NETWORK

(71) Applicant: CELLMAX TECHNOLOGIES AB, Kista (SE)

(72) Inventors: Niclas J. YMAN, Ekerö (US); Stefan JONSSON, Sollentuna (SE); Dan KARLSSON, Sollentuna (SE)

(21) Appl. No.: 15/760,609

(22) PCT Filed: Sep. 15, 2016
(86) PCT No.: PCT/SE2016/050868

§ 371 Date: Mar. 15, 2018

(30) Foreign Application Priority Data
Sep. 15, 2015 (SE) 1551183-5

(51) Int. Cl. H01Q 21/00; H01Q 21/26; H01P 3/06

(52) U.S. Cl. CPC H01Q 21/0006; H01P 3/06; H01Q 21/26; H01Q 21/0087

(57) ABSTRACT

An antenna feeding network for a multi-radiator antenna, the antenna feeding network comprising at least two coaxial lines. Each coaxial line comprises a central inner conductor and an elongated outer conductor surrounding the central inner conductor. At least a first inner conductor and a second inner conductor of the at least two coaxial lines are indirectly interconnected.

### TECHNICAL FIELD

The invention relates to the field of antenna feeding networks for multi-radiator antennas, which feeding network comprises at least two interconnected coaxial lines.

### BACKGROUND OF THE INVENTION

Multi-radiator antennas are frequently used in for example cellular networks. Such multi-radiator antennas comprise a number of radiating antenna elements for example in the form of dipoles for sending or receiving signals, an antenna feeding network and an electrically conductive reflector. The antenna feeding network distributes the signal from a common coaxial connector to the radiators when the antenna is transmitting and combines the signals from the radiators and feeds them to the coaxial connector when receiving. A possible implementation of such a feeding network is shown in FIG. 1.

In such a network, if the splitters/combiners consist of just one junction between 3 different 50 ohm lines, impedance match would not be maintained, and the impedance seen from each port would be 25 ohm instead of 50 ohm. Therefore the splitter/combiner usually also includes an impedance transformation circuit which maintains 50 ohm impedance at all ports.

A person skilled in the art would recognize that the feeding is fully reciprocal in the sense that transmission and reception can be treated in the same way, and to simply the description of this invention only the transmission case is described below.

The antenna feeding network may comprise a plurality of parallel coaxial lines being substantially air filled, each coaxial line comprising a central inner conductor at least partly surrounded by an outer conductor with insulating air in between. The coaxial lines and the reflector may be formed integrally with each other. The splitting may be done via crossover connections between inner conductors of adjacent coaxial lines. In order to preserve the characteristic impedance, the lines connecting to the crossover element include impedance matching structures.

US 2013/01355166 A1 discloses an antenna arrangement comprising an antenna feeding network including at least one antenna feeding line comprising a coaxial line having a central inner conductor and a surrounding outer conductor. The inner conductor is suspended inside the outer conductor with the help of dielectric support means. US 2013/0135166 A1 suggests to use a crossover element to connect two inner conductors of two adjacent coaxial lines. The crossover element is galvanically connected to the inner conductors by means of for example screws, soldering, gluing or a combination thereof, and thus a direct physical contact between the electrically conductive inner conductor and the crossover element is established. Where two conductors need to be connected, the wall between the two coaxial lines is partially or completely removed, and the crossover element is placed in the opening. The antenna arrangement according to US 2013/0135166 has the disadvantage that it may be difficult and time consuming to assemble or manufacture. A further disadvantage with this arrangement is that the mechanical connection formed by the screwed, glued or soldered connection between the lines may introduce passive intermodulation (PIM).

### SUMMARY OF THE INVENTION

An object of the present invention is to overcome at least some of the disadvantages of the prior art described above.

These and other objects are achieved by the present invention by means of an antenna feeding network comprising at least two coaxial lines and a multi radiator antenna comprising such an antenna feeding network according to the independent claims. Preferred embodiments are defined in the dependent claims.

According to a first aspect of the invention, an antenna feeding network for a multi-radiator antenna is provided, the antenna feeding network comprising at least two coaxial lines. Each coaxial line comprises a central inner conductor and an elongated outer conductor surrounding the central inner conductor. At least a first inner conductor and a second inner conductor of the at least two coaxial lines are indirectly interconnected.

In other words, the antenna feeding network comprises at least a first coaxial line and a second coaxial line, wherein the first coaxial line comprises a first inner conductor and an elongated outer conductor surrounding the first inner conductor, and wherein the second coaxial line comprises a second inner conductor and an elongated outer conductor surrounding the second inner conductor. The first inner conductor, the second inner conductor, and optionally further inner conductors, are indirectly interconnected or interconnectable. The coaxial lines may be parallel.

The invention is based on the insight that an antenna feeding network which is easy to assemble, yet provides high performance and low passive intermodulation, may be achieved by indirectly interconnecting inner conductors of the coaxial lines instead of connecting the inner conductors galvanically. Such an indirect interconnection, i.e. capacitive or inductive interconnection or a combination of the two, between the lines may provide an interconnection which does not suffer from the disadvantages associated with mechanical/galvanical connections discussed above.

It is understood that coaxial line refers to an arrangement comprising an inner conductor and an outer conductor with insulating or dielectric material or gas there between, where the outer conductor is coaxial with the inner conductor in the sense that it completely or substantially surrounds the inner conductor. Thus, the outer conductor does not necessarily have to surround the inner conductor completely, but may be provided with openings or slots, which slots may even extend along the full length of the outer conductor.

The at least two coaxial lines may each be provided with air between the inner and outer conductors. The air between the inner and outer conductors thus replaces the dielectric often found in coaxial cables.

In embodiments, at least one, or each, coaxial line of said at least two coaxial lines is provided with at least one support element configured to support the central inner conductor, the support element being located between the outer and inner conductors.

In embodiments, at least one, or each, coaxial line of said at least two coaxial lines is furthermore provided with at least one dielectric element to at least partially fill the cavity between the inner and outer conductors. Such dielectric element(s) is/are preferably slidably movable inside the outer conductor(s) to co-operate with the coaxial line(s) to provide a phase shifting arrangement. The phase shift is achieved by moving the dielectric element that is located between the inner conductor and the outer conductor of the coaxial line. It is a known physical property that introducing a material with higher permittivity than air in a transmission line will reduce the phase velocity of a wave propagating along that transmission line. This can also be perceived as delaying the signal or introducing a phase lag compared to a coaxial line that has no dielectric material between the inner and outer conductors. If the dielectric element is moved in such a way that the outer conductor will be more filled with dielectric material, the phase shift will increase. The at least one dielectric element may have a U-shaped profile such as to partly surround the inner conductor in order to at least partly fill out the cavity between the inner and outer conductors.

In embodiments, two of said at least two coaxial lines form a splitter/combiner. When operating as a splitter, the inner conductor of a first coaxial line is part of the incoming line, and the two ends of the inner conductor of the second coaxial line are the two outputs of the splitter. Thus, the second coaxial line forms two outgoing coaxial lines. In such an embodiment, the dielectric element may be arranged in the second coaxial line in such a way that by moving the dielectric part different amount of dielectric material is present in the respective outgoing coaxial lines. Such an arrangement allows the differential phase of the outputs of a splitter to be varied by adjusting the position of the dielectric part within the splitter. A reciprocal functionality will be obtained when the coaxial line functions as a combiner. Such splitters/combiners having variable differential phase shifting capability are advantageously used in an antennas having radiators positioned in a vertical column, to adjust the electrical antenna tilt angle by adjusting the relative phases of the signals feeding the radiators.

In embodiments where the coaxial line(s) is/are provided with support element(s), dielectric element(s) or other components inside the outer conductor(s), the coaxial line(s) may be described as substantially air filled since these components occupy part of the space inside the outer conductor which would otherwise be filled with air.

In embodiments, the antenna feeding network comprises a connector device configured to indirectly interconnect the at least first and second inner conductors.

Herein the word indirectly means that conductive material of the connector device is not in direct physical contact with the conductive material of the first inner conductor and the second inner conductor, respectively. Indirectly thus means an inductive, a capacitive coupling or a combination of the two.

In embodiments, there may be at least one insulating layer arranged in between the conductive material of the connector device and the conductive material of the inner conductor. This at least one insulating layer may be arranged on the connector device and thus belong to the connector device and/or it may be arranged on the first inner conductor or on the second inner conductor or on both inner conductors. The at least one insulating layer may alternatively comprise a thin film which is arranged between the conductive material of the connector device and the conductive material of the inner conductor. The at least one insulating layer may also be described as an insulating coating. The insulating layer or insulating coating may be made of an electrically insulating material such as a polymer material or a non-conductive oxide material with a thickness of less than 50 μm, such as from 1 μm to 20 μm, such as from 5 μm to 15 μm, such as from 8 μm to 12 μm. Such a polymer or oxide layer may be applied with known processes and high accuracy on the connector device and/or on the inner conductor(s).

In embodiments, the connector device may be configured to be removably connected to the first inner conductor and the second inner conductor. This allows a quick reconfiguration of the antenna feeding network, if necessary or can be used for trouble-shooting in antenna production.

In preferred embodiments, the connector device may be realized as a snap on element comprising at least one pair of snap on fingers and a bridge portion, whereby the snap on fingers may be connected to the bridge portion and wherein the snap on fingers are configured to be snapped onto the first or the second inner conductor. The bridge portion may be configured to connect with the other of the first or the second inner conductor, which is not engaged by the pair of snap on fingers, when the snap on element is snapped onto the first or second inner conductor. The snap on element may comprise two pairs of snap on fingers which are connected by the bridge portion, wherein the two pairs of snap on fingers may be configured to be snapped onto the first inner conductor and the second inner conductor, respectively. These preferred embodiments are advantageous since they allow convenient assembly of the antenna feeding network, where the connector device is simply snapped onto the first and/or second inner conductors. The connector device may also be arranged with two or more bridge portions, connecting three or more pairs of snap on fingers.

In an alternative embodiment, one of the inner conductors comprises a cavity and another of the inner conductors comprises a rod-shaped protrusion configured to extend into and engage with said cavity. An insulating layer is provided in said cavity and/or on said rod-shaped protrusion, or alternatively, an insulating layer is provided as an insulating film between the cavity and the rod-shaped protrusion. Thus, an indirect connection may be provided between two inner conductors. These embodiments are advantageous since they allow convenient assembly of the antenna feeding network, where the inner conductors are interconnected simply by pushing the rod-shaped protrusion into the cavity. Also, this arrangement will reduce the risk for PIM. The cavity may have a depth corresponding to a quarter wavelength.

In yet an alternative embodiment, the connector device comprises at least two engaging portions. Each of the at least first and second inner conductors comprises corresponding engaging portions, each adapted to engage with a corresponding engaging portion of the connector device. The engaging portion is in the form of a cavity or rod-shaped protrusion. An insulating layer is provided in said cavity and/or on said rod-shaped protrusion, or alternatively, an insulating layer is provided as an insulating film between the cavity and the rod-shaped protrusion. Thus, an indirect connection may be provided between two inner conductors. The connector device may in embodiments be provided with three legs, each being provided with an engaging portion at its end to interconnect three inner conductors. For example, the connector device may be provided with cavities at each end of the legs, and three inner conductors may be provided with rod-shaped protrusions adapted to fit and engage in a respective cavity. The cavity or cavities may have a depth corresponding to a quarter wavelength. The connector device may also be arranged such as to connect four or more inner conductors.

The embodiments described above may be combined in any practically realizable way.

According to a second aspect of the invention, a multi radiator base station antenna is provided, which antenna comprises an electrically conductive reflector, at least one radiating element arranged on the reflector and an antenna feeding network as described above.

In an embodiment of the multi-radiator antenna according to the second aspect of the invention, the electrically conductive reflector may comprise at least one opening on the front side or the back side, so that the connector device can be installed on the first and second inner conductor via said opening. The opening may advantageously be adapted to the size of the connector device. An opening may be assigned to each inner conductor pair of the antenna feeding network so that all inner conductors in the electrically conductive reflector may be connected by connector devices.

According to a third aspect of the invention, a method for assembling an antenna feeding network for a multi-radiator antenna is provided. The method comprises providing at least two coaxial lines, wherein each coaxial line is provided with a central inner conductor and an elongated outer conductor surrounding the central inner conductor, and interconnecting at least two inner conductors of the coaxial lines indirectly.

In an embodiment of the method according to the third aspect of the invention, the method further comprises providing a connector device, and providing an insulating layer on the connector device and/or on the at least first and second conductors. Alternatively, an insulating layer is provided between the connector device and said at least first and second conductors. The embodiment further comprises connecting the connector device between the at least first and second inner conductors, wherein the connector device preferably is realized as a snap on element comprising snap on fingers adapted to be snapped onto the at least first and second inner conductors.

In embodiments of a method according the third aspect of the invention, the method is for assembling an antenna feeding network according to the first aspect of the invention or embodiments thereof. Embodiments of the method comprises performing steps to achieve features corresponding to any of the above described embodiments of the antenna feeding network.

### BRIEF DESCRIPTION OF THE DRAWINGS

The present invention will now be described, for exemplary purposes, in more detail by way of embodiments and with reference to the enclosed drawings, in which:

FIG. 1 schematically illustrates a multi-radiator antenna;

FIG. 2 schematically illustrates a perspective view of an embodiment of a multi-radiator antenna according to the second aspect of the invention;

FIG. 3 schematically illustrates a perspective view of an embodiment of an antenna feeding network according to the first aspect of the invention;

FIG. 4 schematically illustrates another perspective view of parts of an embodiment of an antenna feeding network according to the first aspect of the invention;

FIG. 5 schematically illustrates a front view into two neighbouring coaxial lines of an embodiment of an antenna feeding network according to the first aspect of the invention;

FIG. 6 schematically illustrates parts of another embodiment of an antenna feeding network according to the first aspect of the invention; and

FIG. 7 schematically illustrates parts of yet another embodiment of an antenna feeding network according to the first aspect of the invention.

### DETAILED DESCRIPTION OF PREFERRED EMBODIMENTS

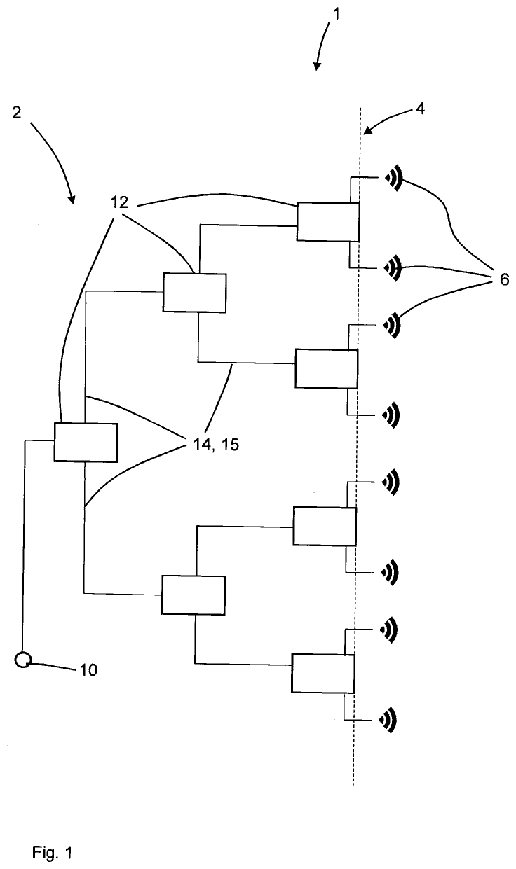

FIG. 1 schematically illustrates an antenna arrangement 1 comprising an antenna feeding network 2, an electrically conductive reflector 4, which is shown schematically in FIG. 1, and a plurality of radiating elements 6. The radiating elements 6 may be dipoles.

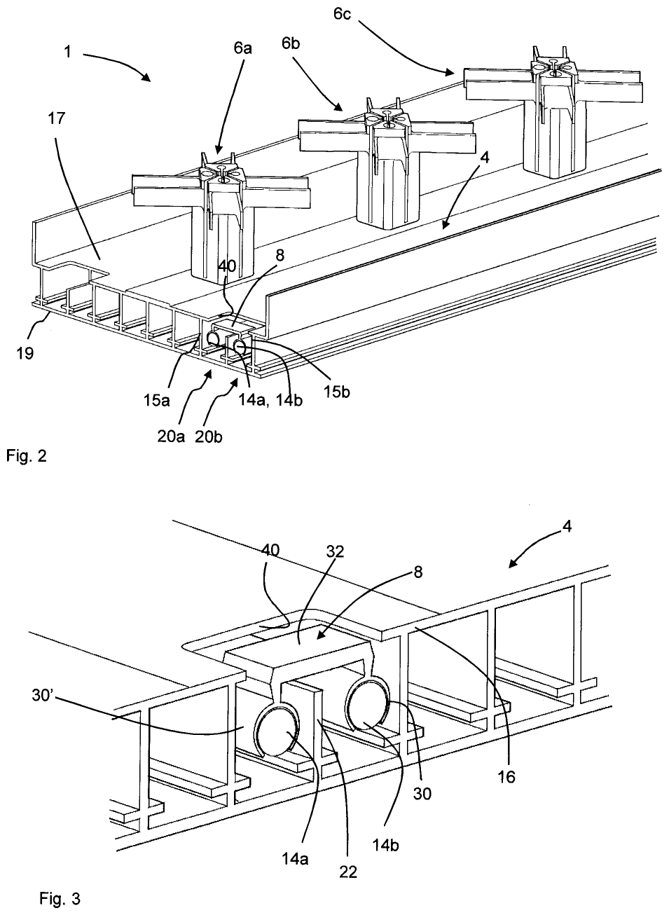

The antenna feeding network 2 connects a coaxial connector 10 to the plurality of radiating elements 6 via a plurality of lines 14, 15, which may be coaxial lines, which are schematically illustrated in FIG. 1. The signal to/from the connector 10 is split/combined using, in this example, three stages of splitters/combiners 12 Turning now to FIG. 2, which illustrates a multi-radiator antenna 1 in a perspective view, the antenna 1 comprises the electrically conductive reflector 4 and radiating elements 6a-c.

The electrically conductive reflector 4 comprises a front side 17, where the radiating elements 6a-c are mounted and a back side 19.

FIG. 2 shows a first coaxial line 20a which comprises a first central inner conductor 14a, an elongated outer conductor 15a forming a cavity or compartment around the central inner conductor, and a corresponding second coaxial line 20b having a second inner conductor 14b and an elongated outer conductor 15b. The outer conductors 15a, 15b have square cross sections and are formed integrally and in parallel to form a self-supporting structure. The wall which separates the coaxial lines 20a, 20b constitute vertical parts of the outer conductors 15a, 15b of both lines. The first and second outer conductors 15a, 15b are formed integrally with the reflector 4 in the sense that the upper and lower walls of the outer conductors are formed by the front side 17 and the back side 19 of the reflector, respectively.

Although the first and second inner conductors 14a, 14b are illustrated as neighbouring inner conductors they may actually be further apart thus having one or more coaxial lines, or empty cavities or compartments, in between.

In FIG. 2 not all longitudinal channels or outer conductors are illustrated with inner conductors, it is however clear that they may comprise such inner conductors.

The front side 17 of the reflector comprises at least one opening 40 for the installation of the connector device 8. The opening 40 extends over the two neighbouring coaxial lines 20a, 20b so that the connector device 8 can engage the first and second inner conductors 14a, 14b.

Although the invention is illustrated with two neighbouring inner conductors 14a, 14b it falls within the scope to have an opening (not shown) that extends across more than two coaxial lines 20a, 20b and to provide a connector device 8 than can bridge two or even more inner conductors. Such a connector device (not shown) may thus be designed so that it extends over a plurality of coaxial lines between two inner conductors or over empty cavities or compartments. Such a connector device (not shown) may also be used to connect three or more inner conductors.

In FIG. 3, an enlarged view of the opening 40 and the connector device 8 arranged therein is illustrated. The connector device 8 is clipped or snapped onto the first inner conductor 14a and the second inner conductor 14b. The connection between the first inner conductor 14a and the second inner conductor 14b is electrically indirect, which means that it is either capacitive, inductive or a combination thereof. This is achieved by providing a thin insulating layer of a polymer material or some other insulating material (e.g. a non-conducting oxide) on the connector device 8. The insulating layer may have a thickness of 1 μm to 20 μm, such as from 5 μm to 15 μm, such as from 8 μm to 12 μm, or may have a thickness of 1 μm to 5 μm. The insulating layer may cover the entire outer surface of the connector device 8, or at least the portions 30, 30′ of the connector device 8 that engage the first and second inner conductors 14a, 14b.

The connector device 8 comprises a bridge portion 32 and two pairs of snap on fingers 30, 30′. One of the two pairs of snap on fingers 30′ is arranged close to one end of the bridge portion 32 and the other of the two pairs of snap on fingers 30 is arranged close to the other end of the bridge portion 32. The two pairs of snap on fingers 30, 30′ may be connected to the bridge portion 32 via connecting portions configured such that the bridge portion 32 is distanced from the first and second inner conductors 14a, 14b. In other embodiments, the snap on fingers 30, 30′ are connected directly to the bridge portion 32. The connecting portions, as well as the other portions of the connector device, are shaped to optimize the impedance matching of the splitter/combiner formed by the connector device and the coaxial lines. The shape, or preferably the diameter of the connecting inner conductors may also contribute to the matching of the splitter/combiner.

As can be seen from FIG. 3, the vertical separating wall portion 22 is cut down to about two-thirds to three-quarters of its original height in the area of the opening 40 so that the connector device 8 does not protrude over the front side 17 of the electrically conductive reflector 4. In other embodiments, the wall portion 22 is cut down all the way to the floor of the outer conductors. The remaining height of the wall portion is adapted together with the other components, such as the connector device to optimize the impedance match.

It may be possible (not shown in the figures) to provide only one pair of snap on fingers, for example the pair of snap on fingers 30′ engaging the first inner conductor 14a providing an indirect connection, and to let the other end of the bridge portion 32 contact the second inner conductor 14b directly without insulating layer or coating. This direct connection can be provided by connecting the bridge portion 32 to inner conductor 14b by means of a screw connection, or by means of soldering, or by making the bridge portion an integral part of inner conductor 14b, or by some other means providing a direct connection.

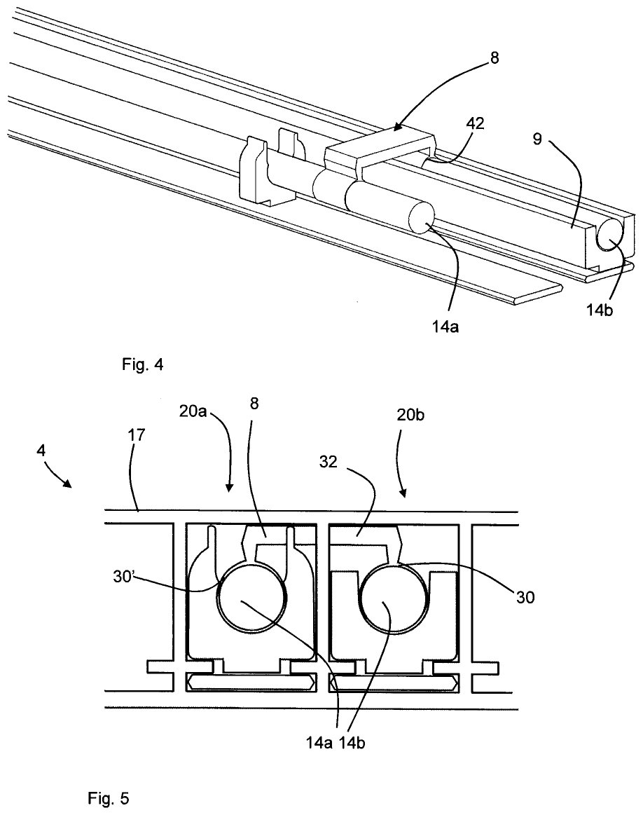

FIG. 4 shows another view of parts of an embodiment of the antenna feeding network. The connector device 8 engages the first and second inner conductors 14a, 14b. The connector device 8 and the inner conductors 14a, 14b together form a splitter/combiner. When operating as a splitter, the inner conductor 14a is part of the incoming line, and the two ends of the inner conductor 14b are the two outputs of the splitter. The U-shaped dielectric element 9 can be moved along the inner conductor 14b, which, together with an outer conductor (not shown), forms first and second coaxial output lines on opposite sides of the connector device 8. The dielectric element thus has various positions along those coaxial output lines.

We first consider the case when the dielectric element 9 is placed in a central position, equally filling the first and second output coaxial lines. When a signal is entered at the input coaxial line 14a, it will be divided between the first output coaxial line and the second output coaxial line, and the signals coming from the two output coaxial lines will be equal in phase. If the dielectric element 9 is moved in such a way that the first output coaxial line will be more filled with dielectric material than the second output coaxial line, the phase shift from the input to the first output will increase. At the same time the second output coaxial line will be less filled with dielectric, and the phase shift from the input to the second output will decrease. Hence, the phase at the first output will lag the phase at the second output. If the dielectric element is moved in the opposite direction, the phase of the first output will lead the phase of the second output. The splitter/combiner may thus be described as a differential phase shifter.

FIG. 4 illustrates how the connector device 8 engages the first and second inner conductors 14a, 14b in circumferential recessed areas or grooves 42 of the first and second inner conductors 14a, 14b. These grooves may be used to position the connector device 8 correctly along the longitudinal direction of the inner conductors 14a, 14b.

FIG. 5 illustrates a view into the first and second coaxial lines 20a, 20b where the connector device 8, bridging the first inner conductor 14a and the second inner conductor 14b is visible. The snap on fingers 30, 30′ are not so well visible since the snap on fingers 30, 30′ engage the first and second inner conductors 14a, 14b in areas with a smaller diameter than the rest of the first and second inner conductors 14a, 14b. FIG. 5 further illustrates that the bridge portion 32 is not extending beyond the front side 17 of the electrically conductive reflector.

The embodiment of the connector device 8 has been described having a thin insulating layer on the connector device 8. It may however be possible to provide the first and second inner conductors 14a, 14b respectively with a very thin insulating layer of a polymer material and provide the connector device without any insulating layer. The insulating layer may cover the entire outer surface of the first and second inner conductors 14a, 14b, or at least the portions where snap on fingers 30, 30′ of the connector device 8 engage the first and second inner conductors 14a, 14b. In other embodiments, an isolating material in the form of a thin foil is placed between the snap-on fingers 30, 30′ and the inner conductor 14.

Further, the connector device 8 has been described illustrating a first and a second inner conductor 14a, 14b in the antenna arrangement 1. The antenna arrangement 1 may however comprise more than one connector device 8 and a plurality of inner conductors 14a, 14b.

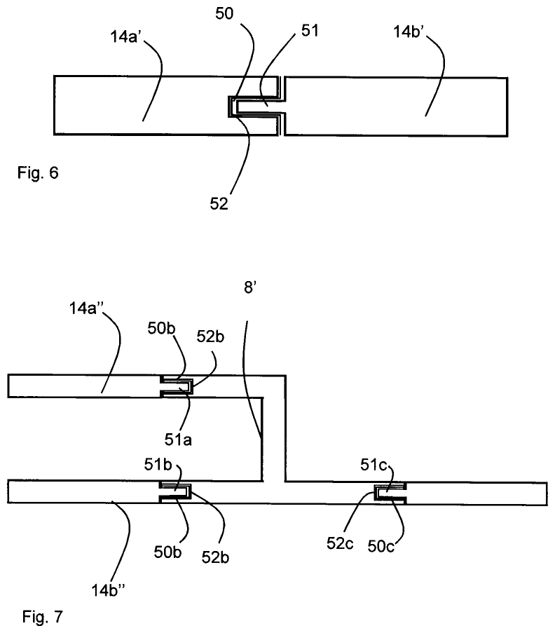

FIG. 6 schematically illustrates parts of another embodiment of an antenna feeding network according to the first aspect of the invention. In FIG. 6, a cross section view is shown of a first inner conductor 14a′ and a second inner conductor 14b′. The first inner conductor 14a′ comprises a cavity 50 extending axially into one of its ends. The second inner conductor 14b′ comprises a rod-shaped protrusion 51 extending axially from one of its ends. The protrusion 51 is adapted to extend into the cavity 50 of the first inner conductor. An insulating layer 52 is provided in and around the cavity to provide an indirect electrical connection between the conductors. In other embodiments, the insulating layer may be provided on the protrusion 51, or as a separate insulating film between the conductors. The insulating layer may be provided as a polymer material or some other insulating material (e.g. a non-conducting oxide) on either or both inner conductors 14a′ or 14b′, completely or partially covering inner conductors 14a′ or 14ab′, or it may be provided as a thin insulating foil inserted between inner conductors 14a′ and 14b′.

FIG. 7 schematically illustrates parts of yet another embodiment of an antenna feeding network according to the first aspect of the invention. In FIG. 7, a cross section view is shown of three inner conductors 14a″, 14b″ and 14c″ and a three legged h-shaped connector device 8′. Each leg of the connector device 8′ is provided with a cavity 50a-c extending axially into their respective ends. The inner conductors 14a″-c″ each comprises a rod-shaped protrusion 51a-c extending axially from one of its ends. The protrusions 51a-c extend into corresponding cavities 50a-c of the connector device. Insulating layers 52a-c are provided in and around the cavities to provide an indirect electrical connection between the conductors. In other embodiments, the insulating layers may be provided on the protrusions, or as separate insulating films between the conductors and the connector device. The h-shaped connector device 8′ may be mounted in a similar manner as the connector device 8, i.e. by cutting down a separating wall between two adjacent outer conductors. In other embodiments, the connector device 8′ is provided with protrusions, and the inner conductors 14″-c″ are provided with cavities.

The description above and the appended drawings are to be considered as non-limiting examples of the invention. The person skilled in the art realizes that several changes and modifications may be made within the scope of the invention. For example, the number of coaxial lines may be varied and the number of radiators/dipoles may be varied. Furthermore, the shape of the connector element (if any) and inner conductors and the placement of the insulating layer or coating may be varied. Furthermore, the reflector does not necessarily need to be formed integrally with the coaxial lines, but may on the contrary be a separate element. The scope of protection is determined by the appended patent claims.

1. An antenna feeding network for a multi-radiator antenna, the antenna feeding network comprising at least two coaxial lines, wherein each coaxial line comprises a central inner conductor and an elongated outer conductor surrounding the central inner conductor, further comprising at least one connector device configured to indirectly interconnect at least a first inner conductor and second inner conductor of said central inner conductors, wherein the connector device is configured to be removably connected to the first inner conductor (14a) and the second inner conductor.

2. The antenna feeding network according to claim 1, wherein the at least two coaxial lines are substantially air filled coaxial lines, each being provided with air between the inner and outer conductors.

3. The antenna feeding network according to claim 1, wherein said at least first and second inner conductors are interconnected capacitively and/or inductively.

4. The antenna feeding network according to claim 1, comprising at least one insulating layer, wherein the insulating layer is arranged on the connector device and/or on the first inner conductor and/or the second inner conductor.

5. The antenna feeding network according to claim 1, comprising at least one insulating layer, wherein the insulating layer is arranged between the connector device and the first inner conductor and/or the second inner conductor.

6. The antenna feeding network according to claim 1 wherein the connector device comprises a core made of an electrically conductive material and an electrically insulating layer arranged around the core.

7. The antenna feeding network according to claim 6, wherein the insulating material is a polymer with a thickness of less than or equal to 50 pm, such as from 1 pm to 20 pm.

8. The antenna feeding network according to claim 1, wherein the connector device is realized as a snap on element comprising at least one pair of snap on fingers and a bridge portion, whereby the snap on fingers are connected to the bridge portion and wherein the snap on fingers are adapted to be snapped onto the first or the second inner conductor.

9. The antenna feeding network according to claim 8, wherein the snap on element comprises two pairs of snap on fingers that are connected by the bridge portion and wherein one of the pairs of snap on fingers are configured to be snapped onto the first inner conductor and the other of the pairs of snap on fingers are configured to be snapped onto the second inner conductor, respectively.

10. The antenna feeding network according to claim 1, wherein the connector device comprises at least two engaging portions, and wherein each of said at least first and second inner conductors comprises corresponding engaging portions, each adapted to engage with a corresponding engaging portion of the connector device, wherein each engaging portion is in the form of a cavity or rod-shaped protrusion.

11. The antenna feeding network according to claim 10, wherein the connector device is provided with three legs, each being provided with an engaging portion at its end to interconnect three inner conductors.

12. The antenna feeding network according to claim 1, wherein one of the first and second inner conductors comprises a cavity and wherein the other inner conductor comprises a rod-shaped protrusion configured to extend into and engage with said cavity, wherein an insulating layer is provided in said cavity and/or on said rod-shaped protrusion, or wherein an insulating layer is provided between said cavity and said rod-shaped protrusion.

13. The antenna feeding network according to claim 10, wherein said protrusion has a length of a quarter of a wavelength.

14. A multi radiator antenna comprising an electrically conductive reflector, at least one radiating element arranged on said reflector and an antenna feeding network, said radiating elements being connected to said antenna feeding network, said antenna feeding network comprising at least two coaxial lines, wherein each coaxial line comprises a central inner conductor and an elongated outer conductor surrounding the central inner conductor, further comprising at least one connector device configured to indirectly interconnect at least a first inner conductor and second inner conductor of said central inner conductors, wherein the connector device is configured to be removably connected to the first inner conductor (14a) and the second inner conductor.

15. The multi radiator antenna according to claim 14, wherein the electrically conductive reflector comprises at least one opening on the front side or the back side adapted to the size of the connector device such that said connector device can be installed via said opening.

16. A method for assembling an antenna feeding network for a multi-radiator antenna, said method comprising:
providing at least two coaxial lines, wherein each coaxial line is provided with a central inner conductor and an elongated outer conductor surrounding the central inner conductor; and
interconnecting at least a first inner conductor and a second inner conductor of said central inner conductors indirectly
providing a connector device; and
providing an insulating layer on said connector device and/or on said at least first and second conductors, or providing an insulating layer between said connector device and said at least first and second conductors;
wherein said interconnecting comprises connecting said connector device between said at least first and second inner conductors, wherein said connector device is adapted to be removably connected to the first inner conductor and the second inner conductor.

17. The method according to claim 18, wherein said connector device is realized as a snap on element comprising snap on fingers adapted to be snapped onto the at least first and second inner conductors.

18. The multi radiator antenna according to claim 14, wherein the at least two coaxial lines are substantially air filled coaxial lines, each being provided with air between the inner and outer conductors.

19. The multi radiator antenna according to claim 14, wherein said at least first and second inner conductors are interconnected capacitively and/or inductively.

20. The multi radiator antenna according to claim 14, comprising at least one insulating layer, wherein the insulating layer is arranged on the connector device and/or on the first inner conductor and/or the second inner conductor.

21. The multi radiator antenna according to claim 14, comprising at least one insulating layer, wherein the insulating layer is arranged between the connector device and the first inner conductor and/or the second inner conductor.

22. The multi radiator antenna according to claim 14, wherein the connector device comprises a core made of an electrically conductive material and an electrically insulating layer arranged around the core.

23. The multi radiator antenna according to claim 14, wherein the insulating material is a polymer with a thickness of less than or equal to 50 pm, such as from 1 pm to 20 pm.

24. The multi radiator antenna according to claim 14, wherein the connector device is realized as a snap on element comprising at least one pair of snap on fingers and a bridge portion, whereby the snap on fingers are connected to the bridge portion and wherein the snap on fingers are adapted to be snapped onto the first or the second inner conductor.

25. The multi radiator antenna according to claim 24, wherein the snap on element comprises two pairs of snap on fingers that are connected by the bridge portion and wherein one of the pairs of snap on fingers are configured to be snapped onto the first inner conductor and the other of the pairs of snap on fingers are configured to be snapped onto the second inner conductor, respectively.

26. The multi radiator antenna according to claim 14, wherein the connector device comprises at least two engaging portions, and wherein each of said at least first and second inner conductors comprises corresponding engaging portions, each adapted to engage with a corresponding engaging portion of the connector device, wherein each engaging portion is in the form of a cavity or rod-shaped protrusion.

27. The multi radiator antenna according to claim 26, wherein the connector device is provided with three legs, each being provided with an engaging portion at its end to interconnect three inner conductors.

28. The multi radiator antenna according to claim 14, wherein one of the first and second inner conductors comprises a cavity and wherein the other inner conductor comprises a rod-shaped protrusion configured to extend into and engage with said cavity, wherein an insulating layer is provided in said cavity and/or on said rod-shaped protrusion, or wherein an insulating layer is provided between said cavity and said rod-shaped protrusion.

29. The multi radiator antenna according to claim 26, wherein said protrusion has a length of a quarter of a wavelength.
